(19) United States
(12) Patent Application Publication
(10) Pub. No.: US 2022/0196799 A1
(43) Pub. Date: Jun. 23, 2022

(54) TUNABLE OPTICAL FILTER LASER SOURCE FEEDBACK

(71) Applicant: Beijing Voyager Technology Co., Ltd., Beijing (CN)

(72) Inventors: An-Chun Tien, Mountain View, CA (US); Yue Lu, Mountain View, CA (US); Youmin Wang, Mountain View, CA (US)

(21) Appl. No.: 17/131,552

(22) Filed: Dec. 22, 2020

(51) Int. Cl. G01S 7/481; G01S 7/4861; G01S 7/4913; G02F 1/13; G02F 1/21

(52) U.S. Cl. CPC G01S 7/4811; G01S 7/4817; G01S 7/4861; G01S 17/931; G02F 1/132; G02F 1/213; G01S 7/4913

(57) ABSTRACT

A tunable optical filter provides a narrow passband centered around the wavelength of the laser beam to limit ambient light noise impinging on a primary photodetector. As the wavelength changes due to temperature or other effects, the wavelength is indirectly measured and used to shift the passband of the filter to center it on the shifted wavelength. A portion of the emitted beam is diverted through the same tunable filter to a feedback photodetector. The output of the feedback photodetector will be at a maximum value when the tunable filter passband is centered on the laser beam wavelength. By controlling the passband of the tunable filter to maximize the feedback photodetector output, the passband remains centered on the laser wavelength. The tunable filter is a Liquid Crystal Tunable Filter (LCTF) or another tunable filter large enough to pass both reflected and feedback light to the primary and feedback photodetectors.

### BACKGROUND OF THE INVENTION

Unless otherwise indicated herein, the materials described in this section are not prior art to the claims in this application and are not admitted to be prior art by inclusion in this section. In particular, disparate technologies are discussed that it would not be obvious to discuss together absent the teachings of the present invention.

Modern vehicles are often equipped with sensors designed to detect objects and landscape features around the vehicle in real-time to enable technologies such as lane change assistance, collision avoidance, and autonomous driving. Some commonly used sensors include image sensors (e.g., infrared or visible light cameras), acoustic sensors (e.g., ultrasonic parking sensors), radio detection and ranging (RADAR) sensors, magnetometers (e.g., passive sensing of large ferrous objects, such as trucks, cars, or rail cars), and light detection and ranging (LiDAR) sensors.

A LiDAR system typically uses a light source and a light detection system to estimate distances to environmental features (e.g., pedestrians, vehicles, structures, plants, etc.). For example, a LiDAR system may transmit a light beam (e.g., a pulsed laser beam) to illuminate a target and then measure the time it takes for the transmitted light beam to arrive at the target and then return to a receiver near the transmitter or at a known location. In some LiDAR systems, the light beam emitted by the light source may be steered across a two-dimensional or three-dimensional region of interest according to a scanning pattern, to generate a “point cloud” that includes a collection of data points corresponding to target points in the region of interest. The data points in the point cloud may be dynamically and continuously updated, and may be used to estimate, for example, a distance, dimension, location, and speed of an object relative to the LiDAR system.

In a LiDAR system, solar light has a spectrum that overlaps with that of the laser emitter, and is typically the strongest noise source. Usually, a well-designed optical filter that matches the spectrum of the emitter laser helps to reject all of the out-of-band wavelength solar light. However for a LiDAR deployed on the vehicle, due to the various operation conditions, for example wide temperature range (typically from −40° C. to 140° C.) as required by vehicle regulation standards, the emitter laser wavelength is not a fixed constant. The laser wavelength shifts due to temperature changes, which causes refractive index changes of its active area gain material, and its etalon filter characteristics. To accommodate this wavelength shift, the filter is often set with a wider spectral range to guarantee no signal light from the laser is cut off. However this in return widens the solar noise acceptance range and compromises the overall signal to noise ratio (SNR).

Some systems use a tunable bandpass filter with a narrow bandpass, and tune the filter to follow the wavelength of the laser beam. The wavelength can be measured directly, or test pulses can be used to calibrate the tunable filter. However, detecting the wavelength adds complexity and cost, and using test pulses means those pulses pick up noise from the environment. It would be desirable to have a simpler and more reliable solution.

### BRIEF SUMMARY OF THE INVENTION

Techniques disclosed herein relate generally to bandpass optical filter systems that can be used, for example, in light detection and ranging (LiDAR) systems or other light beam steering systems. More specifically, and without limitation, disclosed herein are apparatus and methods for indirectly measuring the output wavelength and effectively adjusting a filtered bandwidth in real time.

According to certain embodiments, a laser is provided to emit a laser beam. A tunable optical filter is mounted to receive a reflected laser beam off an object in an external environment. A primary photodetector is mounted to receive the reflected light beam after passing through the tunable optical filter. A separate feedback path is provided with an optical subsystem for redirecting a portion of the laser beam emitted from the laser diode as a feedback beam through the same tunable optical filter. A feedback photodetector detects the feedback beam. A controller is coupled to the feedback photodetector and controls the passband of the tunable optical filter to track the wavelength of the laser beam.

In certain embodiments, a tunable optical filter provides a narrow passband centered around the wavelength of a laser beam to limit noise due to ambient light impinging on a primary photodetector. As the wavelength changes due to temperature or other effects, the wavelength is indirectly measured and used to shift the passband of the filter to center it on the shifted wavelength. A portion of the emitted beam is diverted in a feedback path through the same tunable filter to a feedback photodetector. The output of the feedback photodetector will be at a maximum value when the tunable filter passband is centered on the laser beam wavelength. By controlling the passband of the tunable filter to maximize the feedback photodetector output, the passband remains centered on the laser wavelength. The amplitude of the feedback photodetector signal is an indirect measure of the laser wavelength. This simple and elegant system does not need to know the absolute wavelength or temperature.

In one embodiment, the tunable filter is a Liquid Crystal Tunable Filter (LCTF) or another tunable filter large enough to pass both reflected and feedback light to the primary and feedback photodetectors. Typically, this means a filter that is from 5 to 10 mm across.

According to some embodiments, the tunable optical filter is a Liquid Crystal Tunable Filter (LCTF) or a Micro-Electro-Mechanical System (MEMS) Fabry-Perot filter. The optical feedback subsystem uses a prism with a coated surface to reflect less than 25% of the laser beam, or less than 5-8%. Alternately, a coated glass plate or other reflective device can be used. For a Liquid Crystal Tunable Filter (LCTF), which switches faster at higher temperatures, the LCTF is heated with heating resistors and monitored with a thermistor. Using embodiments of the present invention, the passband can be reduced to 25 nanometers or less, such as 20 nanometers.

According to certain embodiments, a method for feedback control of a tunable filter includes emitting a light beam from a light emitter and directing reflected light from the light emitter off an external environment through a tunable optical bandpass filter (to filter ambient light noise), where it is detected with a primary photodetector. A portion of the light beam emitted from the light emitter is redirected as a feedback beam through the tunable optical bandpass filter without reflecting off objects in the external environment. The feedback beam is detected with a feedback photodetector. In response to detecting the feedback beam, the passband of the tunable optical bandpass filter is controlled to track the wavelength of the light beam.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention, will be more apparent from the following detailed description taken in conjunction with the accompanying drawings, in which:

FIG. 1 shows an autonomous vehicle with a LiDAR system, according to certain embodiments;

FIG. 2A shows an example of a light projection operation, according to certain embodiments;

FIG. 2B shows an example of a light detection operation, according to certain embodiments;

FIG. 3 is a diagram illustrating a feedback control for a tunable filter according to certain embodiments;

FIG. 4 is a diagram of a MEMS LiDAR system including a tunable filter feedback control system according to certain embodiments;

FIG. 5 is a diagram illustrating an embodiment of a liquid crystal tunable filter (LCTF) according to the prior art;

FIG. 6 is a diagram illustrating an embodiment of the control electronics for a tunable filter with feedback control according to certain embodiments;

FIG. 7 is a flow chart of a method for feedback control of a tunable filter according to embodiments;

FIG. 8 illustrates a simplified block diagram showing aspects of a LiDAR-based detection system, according to certain embodiments of the invention; and

FIG. 9 illustrates an example computer system that may be utilized to implement techniques disclosed herein, according to certain embodiments of the invention.

### DETAILED DESCRIPTION OF THE INVENTION

Aspects of the present disclosure relate generally to bandpass optical filter systems that can be used, for example, in light detection and ranging (LiDAR) systems or other light beam detection systems. More specifically, disclosed herein are apparatus and methods for indirectly measuring the output wavelength and effectively adjusting a filtered bandwidth in real time.

In the following description, various examples of a feedback control system for a tunable filter are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

The use of a narrow bandpass filter instead of a wide bandpass eliminates much of the ambient light and thus improves the signal to noise ratio. But there is a tradeoff, since the efficiency of a narrow bandpass, tunable filter is typically 50-60%. The wider the filter bandwidth, the higher the efficiency. For LiDAR, it is desirable to have a filter bandwidth that is as narrow as possible. For a 20 nm filter passband, typically there is 40-50% filter efficiency. However, by reducing the passband from 100-20 nm, this can reduce background noise by 80%, more than the efficiency reduction of the narrow passband.

When the temperature changes, the laser wavelength moves away from the peak of the bandpass filter leading to a decrease of the photodetector signal. In a LiDAR application, the laser tends to run hot, and its temperature changes slowly in reaction to ambient temperature changes—in the range of seconds or more often minutes. With microelectronics and tunable filters that can react in milliseconds, this provides an opportunity for real time adjustments.

The following high level summary is intended to provide a basic understanding of some of the novel innovations depicted in the figures and presented in the corresponding descriptions provided below. Techniques disclosed herein relate generally to a tunable optical filter that provides a narrow passband centered around the wavelength of a laser beam to limit noise due to ambient light impinging on a primary photodetector. As the wavelength changes due to temperature or other effects, the wavelength is indirectly measured and used to shift the passband of the filter to center it on the shifted wavelength. A portion of the emitted beam is diverted through the same tunable filter to a feedback photodetector. Thus, the effect of the tunable filter can be measure without using the actual operational light path for object detection. The output of the feedback photodetector will be at a maximum value when the tunable filter passband is centered on the laser beam wavelength. By controlling the passband of the tunable filter to maximize the feedback photodetector output, the passband remains centered on the laser wavelength. The tunable filter is a Liquid Crystal Tunable Filter (LCTF) or another tunable filter large enough to pass both target returned and feedback light to the primary and feedback photodetectors.

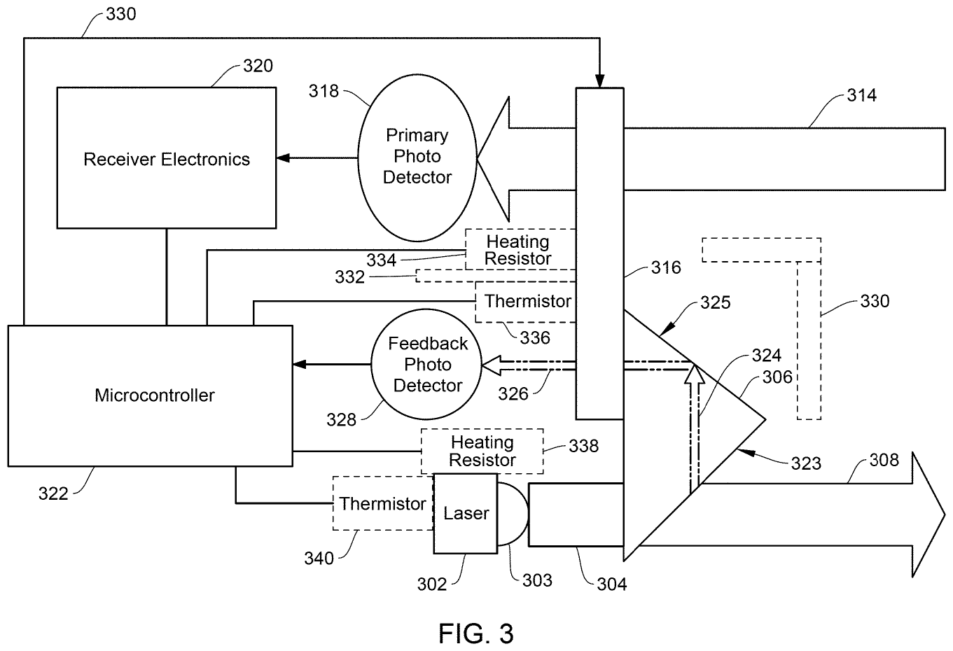

More specifically, and without limitation, disclosed herein is a system with a laser 302 as shown in FIG. 3 that emits a laser beam. A tunable optical filter 316 is mounted to receive a reflected laser beam off an object in an external environment. A primary photodetector 318 is mounted to receive the reflected light beam after passing through the tunable optical filter. A separate feedback path is provided with an optical subsystem for redirecting a portion of the laser beam emitted from the laser diode as a feedback beam through the same tunable optical filter. That optical subsystem can be a prism 306 with a partially reflective surface 323, a coated glass plate, or other optical device. A feedback photodetector 328 detects the feedback beam. A controller 322 is coupled to the feedback photodetector and controls the passband of the tunable optical filter to track the wavelength of the laser beam.

The system of these embodiments will track the wavelength with the maximum amplitude of the photo detector signal even if the power output of the laser changes over time with age, or in the short term for other reasons. The system will simply adapt to the new power level, finding the maximum feedback photodetector amplitude at that power level.

### Typical Lidar System Environment for Certain Embodiments of the Invention

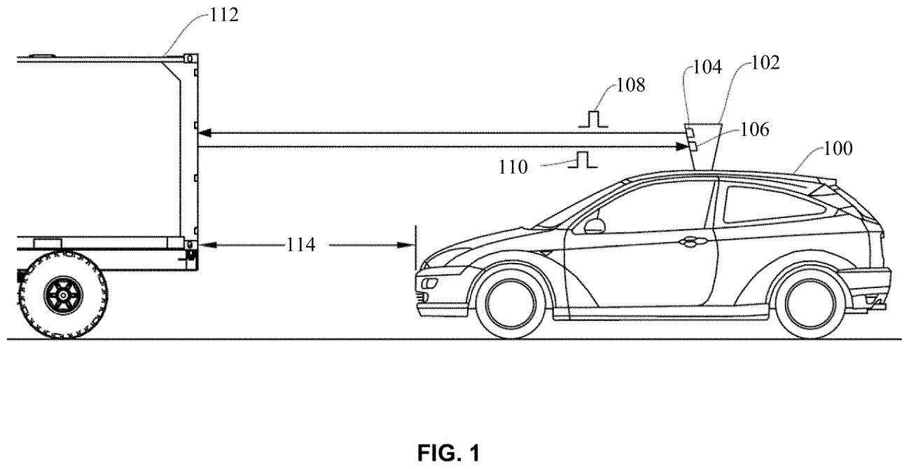

FIG. 1 illustrates an autonomous vehicle 100 in which the various embodiments described herein can be implemented. Autonomous vehicle 100 can include a LiDAR module 102. LiDAR module 102 allows autonomous vehicle 100 to perform object detection and ranging in a surrounding environment. Based on the result of object detection and ranging, autonomous vehicle 100 can drive according to the rules of the road and maneuver to avoid a collision with detected objects. LiDAR module 102 can include a light steering transmitter 104 and a receiver 106. Light steering transmitter 104 can project one or more light signals 108 at various directions (e.g., incident angles) at different times in any suitable scanning pattern, while receiver 106 can monitor for a light signal 110 which is generated by the reflection of light signal 108 by an object. Light signals 108 and 110 may include, for example, a light pulse, an amplitude modulated continuous wave (AMCW) signal, etc. LiDAR module 102 can detect the object based on the reception of light signal 110, and can perform a ranging determination (e.g., a distance of the object) based on a time difference between light signals 108 and 110, as would be appreciated by one of ordinary skill in the art with the benefit of this disclosure. For example, as shown in FIG. 1, LiDAR module 102 can transmit light signal 108 at a direction directly in front of autonomous vehicle 100 at time T1 and receive light signal 110 reflected by an object 112 (e.g., another vehicle) at time T2. Based on the reception of light signal 110, LiDAR module 102 can determine that object 112 is directly in front of autonomous vehicle 100. Moreover, based on the time difference between T1 and T2, LiDAR module 102 can also determine a distance 114 between autonomous vehicle 100 and object 112. Autonomous vehicle 100 can thereby adjust its speed (e.g., slowing or stopping) to avoid collision with object 112 based on the detection and ranging of object 112 by LiDAR module 102.

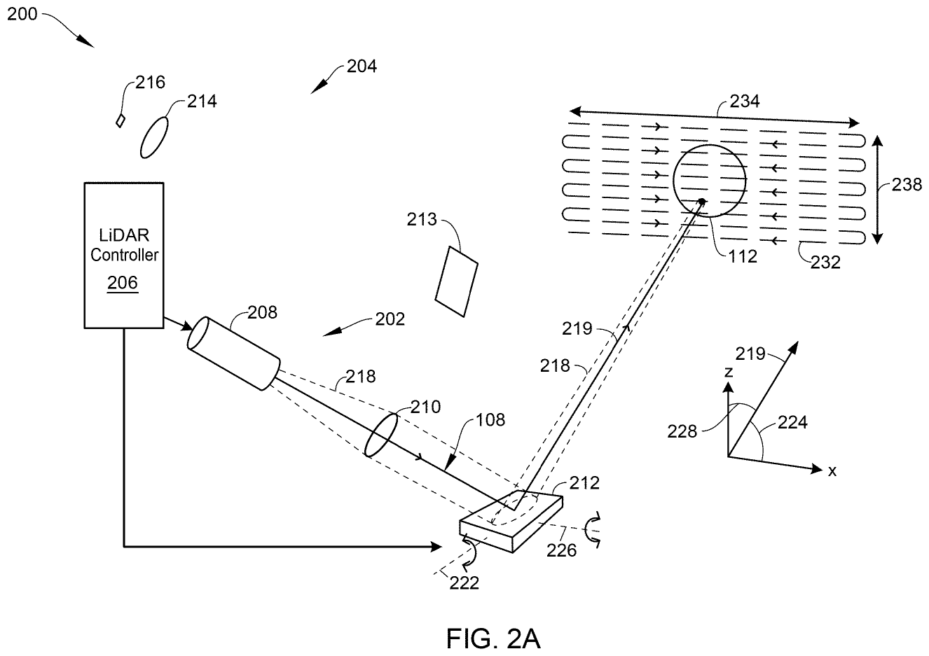

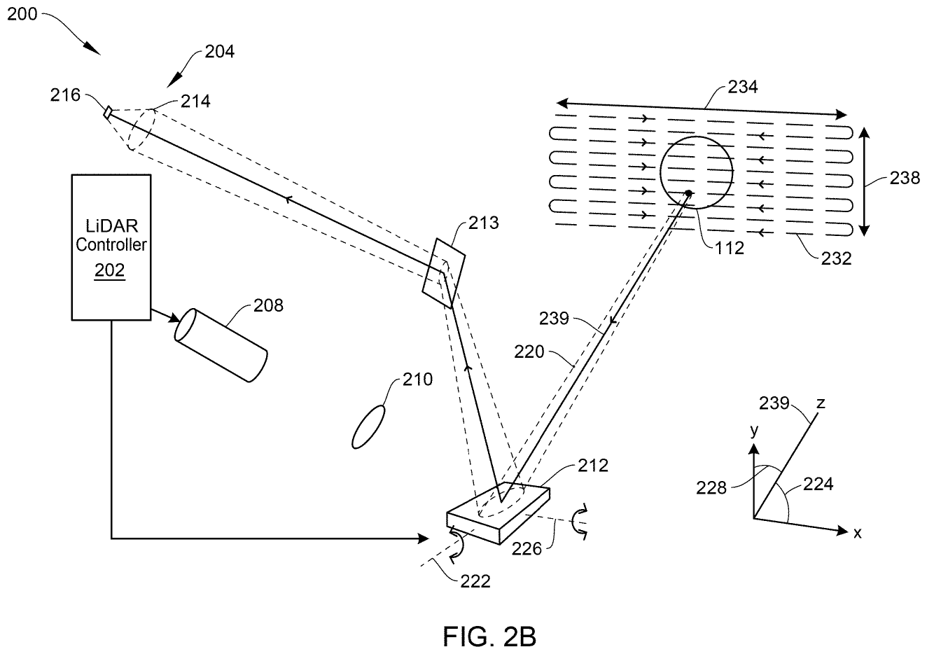

FIG. 2A and FIG. 2B illustrate simplified block diagrams of an example of a LiDAR module 200 according to certain embodiments. LiDAR module 200 may be an example of LiDAR system 102, and may include a transmitter 202, a receiver 204, and LiDAR controller 206, which may be configured to control the operations of transmitter 202 and receiver 204. Transmitter 202 may include a light source 208 and a collimator lens 210, and receiver 204 can include a lens 214 and a photodetector 216. LiDAR module 200 may further include a mirror assembly 212 (also referred to as a “mirror structure”) and a beam splitter 213. In some embodiments, LiDAR module 102, transmitter 202 and receiver 204 can be configured as a coaxial system to share mirror assembly 212 to perform light steering operations, with beam splitter 213 configured to reflect incident light reflected by mirror assembly 212 to receiver 204.

FIG. 2A shows an example of a light projection operation, according to certain embodiments. To project light, LiDAR controller 206 can control light source 208 (e.g., a pulsed laser diode, a source of FMCW signal, AMCW signal, etc.) to transmit light signal 108 as part of light beam 218. Light beam 218 can disperse upon leaving light source 208 and can be converted into collimated light beam 218 by collimator lens 210. Collimated light beam 218 can be incident upon a mirror assembly 212, which can reflect collimated light beam 218 to steer it along an output projection path 219 towards object 112. Mirror assembly 212 can include one or more rotatable mirrors. FIG. 2A illustrates mirror assembly 212 as having one mirror; however, a micro-mirror array may include multiple micro-mirror assemblies that can collectively provide the steering capability described herein. Mirror assembly 212 can further include one or more actuators (not shown in FIG. 2A) to rotate the rotatable mirrors. The actuators can rotate the rotatable mirrors around a first axis 222, and can rotate the rotatable mirrors along a second axis 226. The rotation around first axis 222 can change a first angle 224 of output projection path 219 with respect to a first dimension (e.g., the x-axis), whereas the rotation around second axis 226 can change a second angle 228 of output projection path 219 with respect to a second dimension (e.g., the z-axis). LiDAR controller 206 can control the actuators to produce different combinations of angles of rotation around first axis 222 and second axis 226 such that the movement of output projection path 219 can follow a scanning pattern 232. A range 234 of movement of output projection path 219 along the x-axis, as well as a range 238 of movement of output projection path 219 along the z-axis, can define a FOV. An object within the FOV, such as object 112, can receive and reflect collimated light beam 218 to form reflected light signal, which can be received by receiver 204 and detected by the LiDAR module, as further described below with respect to FIG. 2B. In certain embodiments, mirror assembly 212 can include one or more comb spines with comb electrodes (see, e.g., FIG. 3), as will be described in further detail below.

FIG. 2B shows an example of a light detection operation, according to certain embodiments. LiDAR controller 206 can select an incident light direction 239 for detection of incident light by receiver 204. The selection can be based on setting the angles of rotation of the rotatable mirrors of mirror assembly 212, such that only light beam 220 propagating along light direction 239 gets reflected to beam splitter 213, which can then divert light beam 220 to photodetector 216 via collimator lens 214. With such arrangements, receiver 204 can selectively receive signals that are relevant for the ranging/imaging of object 112 (or any other object within the FOV), such as light signal 110 generated by the reflection of collimated light beam 218 by object 112, and not to receive other signals. As a result, the effect of environmental disturbance on the ranging and imaging of the object can be reduced, and the system performance may be improved.

### Tunable Filter Feedback System

FIG. 3 is a diagram illustrating a feedback control for a tunable filter according to certain embodiments. A laser diode 302 emits, through collimating optics 303, a light beam 304, the majority of which passes through a prism 306 as light beam 308. Alternately, any other partial reflector can be used, such as, for instance, a glass plate with anti-reflective coating on one side and no coating on the other side. Light beam 308 is directed by a MEMS mirror assembly (see FIGS. 2A and 2B) to scan an environment to be detected, with light reflected off objects returning as light beam 314. Reflected light beam 314 passes through a bandpass tunable filter 316, to eliminate most of the ambient light radiation. A primary photodetector 318 detects the received light, and provides a detector signal which is processed through receiver electronics 320 and provided to microcontroller 322.

A feedback path from the laser source is provide with a partially reflective surface 323 on prism 306, which reflects a small portion of the light (e.g., 2-4%) as a reflected beam 324, which is further reflected by prism edge 325 as beam 326. With a prism reflector shown in the figure, when there is no coating, the total internal reflection directs all the optical power to the feedback photodiode 328. Thus, no coating is needed on the prism surface 325. A coating may be added to surface 323 to allow the majority of the optical power to transmit. In one embodiment, surface 323 has a coating which transmits at least 95% of the laser beam, and only reflects 5% or less. This provides sufficient reflection for the feedback control, while minimizing the effect on the transmitted beam. Alternately, an uncoated thin glass plate (instead of a prism) can be used, and the amount of light being directed to the feedback photodetector may be 5-10%, or about 8%. In another embodiment, the amount of the laser beam reflected for feedback is less than 25%. There is a tradeoff, since more power is desired in the transmitted laser beam, but the feedback control (for wavelength tracking) is less sensitive to noise when a larger portion of the laser power is used for feedback.

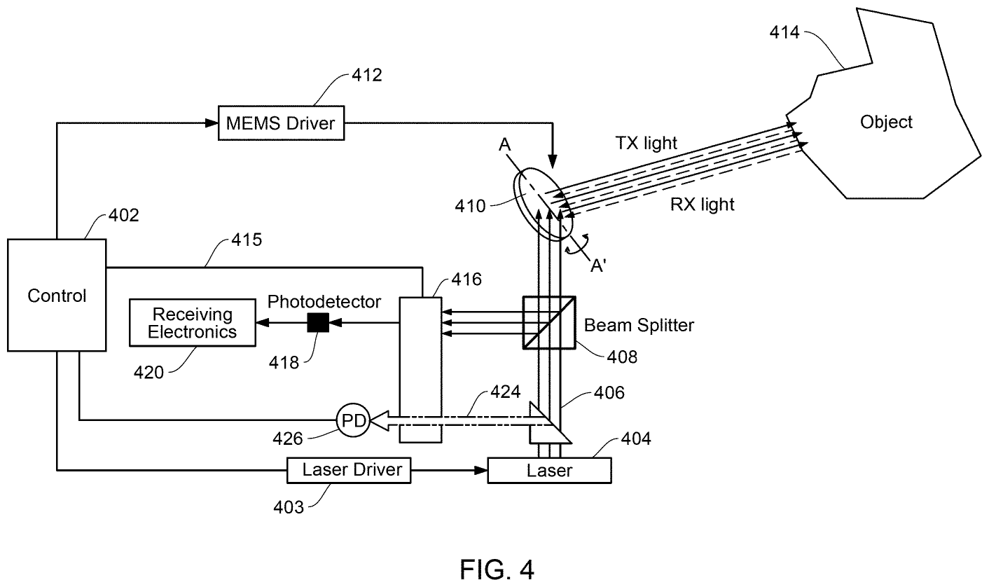

Feedback beam 326, after reflecting off another surface of prism 306, passes through the same tunable filter 316 as the reflected light beam 314. Other shaped prisms or optics could be used, for example to directed the feedback beam at a 90 degree angle as shown in FIG. 4, rather than 180 degrees as shown in FIG. 3. Feedback beam 326 is detected by a feedback photodetector 328, with the amplitude of the detected light being provided to microcontroller 322 (though receiver electronics not shown, with some detail shown in FIG. 4), or a separate controller or control circuit. The amount of the reflected beam can vary from system to system, as long as the amount is constant over a short time and there is constant reflectivity. It is desirable to divert as little from the main laser beam as possible, to minimize power requirements and maximize the ability to detect objects at a distance. Some prisms will reflect and feedback a small portion of the laser beam without requiring any specially coated surface.

In one embodiment, the passband of bandpass tunable filter 316 is initially set with the center of the bandpass at the expected wavelength of the laser 302 at the expected average operating temperature. For example, the anticipated laser wavelength may be 900 nm, and the passband would be set to 880-920 nm, centered around 900 nm. The system can optionally allow some time for the laser to warm up to its operating temperature, then begin to determine if the passband needs to be adjusted due to a change in the laser beam wavelength. The center of the passband could be moved to 899 nm, with a passband of 879-919 nm. The amplitude of the detected signal from photodetector 328 at the new passband centered on 899 nm is compared to the detected signal when the center of the passband was 900 nm. If the amplitude is higher, the passband is further shifted to center on 898 nm. As long as the amplitude is higher, the passband continues to shift. Once the passband begins to lower, that indicates that the passband has shifted too far, past the optimum passband, and the passband is increased back to the previously detected maximum. If the initial movement to 899 nm resulted in a lower amplitude, the changes would have been reversed to a positive direction, changing the passband center to 901 nm, then 902 nm, etc., until the maximum is detected.

Alternately, upon initialization (for example in the first 10 seconds), the system may do a sweep through a wide range of wavelengths for calibration. For example, the tunable filter could have the middle of the passband shift incrementally from the shortest wavelength to the longest. The amplitude of the signal from the feedback photodetector would be recorded in a table along with the corresponding wavelength. The results can then be examine to determine the maximum value of the photodetector, which would correspond to the laser bandwidth. Because the amount of variation of the wavelength with temperature is limited, the sweep can be restricted to wavelengths corresponding to an operational temperature range, such as −40 to +85 degrees Celsius. Such a sweep would identify false local peaks in the photodetector signal that the system might otherwise lock onto.

Except upon start-up, the temperature of the laser 302 would almost always change very slowly, over many seconds or minutes. Thus, microcontroller 322 need not check the amplitude of feedback photodetector 328 more than every few seconds at the most. If a change in amplitude is detected, the above routine of searching for the best passband can be executed, with very rapid changes in the passband. Depending on the speed with which the tunable filter passband can be changed, it could potentially be changed as fast as the pulse rate at which the laser diode is activated. Alternately, the amplitude of the photodetector is measured over a number of pulses to obtain an average amplitude, and eliminate or average out fluctuations due to ambient noise. In some embodiments, the pulse repetition frequency can be as high as about 500 kHz, which translates to 2 microseconds between two adjacent laser pulses. The response time for liquid crystals is typically on the order of several milliseconds or slower. In this example, the slow response time of the tuner is probably the dominating factor of this feedback mechanism. One can use this tuner response time to obtain the average of the signals from all the laser pulses. Alternately, the average can be obtained by using a slow feedback photodetector (a slow photodiode and/or slow electronics).

In one embodiment, the portion of prism 306 in front of feedback photodetector 328 has an optional barrier 330 to minimize ambient light reaching feedback photodetector 328. In this way, the detected light is almost entirely the reflected feedback laser beam. Additionally, an optional barrier 332 may be placed between feedback photodetector 328 and primary photodetector 318. In one embodiment, the prism and all the other feedback components are packaged in a housing, so any “leakage” of the ambient light is likely eliminated by the housing.

In embodiments of the invention, the tunable filter can be a MEMS Fabry-Perot filter, a liquid crystal based filter, an acousto-optic tunable filter (AOTF), a linear-variable filter (LVF), or any other tunable filter. For embodiments with a liquid crystal tunable filter (LCTF), the switching speed of the tunable filter increases with increasing temperature. Thus, a heating resistor 334 may optionally be added to keep LCTF 316 at a sufficiently high temperature. An optional thermistor 336 can measure the temperature and provide feedback to microcontroller 322 to maintain the desired temperature. Additionally, a heating resistor(s) 338 and thermistor 340 can optionally be added near laser 302 to heat it to a minimum temperature. This limits the range of changes of the wavelength to those associated with higher temperatures, rather than both high and low temperatures. Microcontroller 322 causes the heating resistor 338 to heat laser diode 302 until a desired, threshold temperature is reached. When that temperature is exceeded, the heating resistor is turned off. In an alternate embodiment, the laser diode and tunable filter are mounted close enough to each other that a single combined heating resistor and thermistor could be used. In another embodiment, the thermistor can be eliminated, with the current provided to the heating resistor being varied until the microcontroller detects an optimum switching speed of the tunable optical filter. The switching speed can be determined by how quickly a new amplitude value from the feedback photodetector settles on a fixed value after a change in passband.

FIG. 4 is a diagram of a MEMS LiDAR system including a tunable filter feedback control system according to certain embodiments. A controller 402 controls a laser driver 403 and laser 404, which emits a laser beam 406. The laser beam 406 passes through a beam splitter 408 and is scanned by rotating micro-mirrors 410 across an object 414 to be detected. The movement of the micro-mirrors is controlled by a MEMS driver 412 under the control of controller 402. The reflected beams are again directed off the micro-mirrors 410 to beam splitter 408, which then redirects the reflected beams to a tunable bandpass filter 416. The filtered light is provided to a photodetector 418, which is then processed by receiving electronics 420.

A separate feedback path as described in FIG. 3 is included. A portion of laser beam 406 is reflected by a prism 422 as beam 424. Reflected beam 424 is directed through the same tunable bandpass filter 416 and is detected by a separate feedback photodetector 426. In this embodiment, only one surface of prism 422 is partially reflective, so that reflected beam 424 only reflects off one surface of prism 422, rather than two surfaces as in the embodiment of FIG. 3. Any other combination of optics can be used to redirect a portion of laser beam 406 depending on the ideal location of photodetector 426 in any particular system.

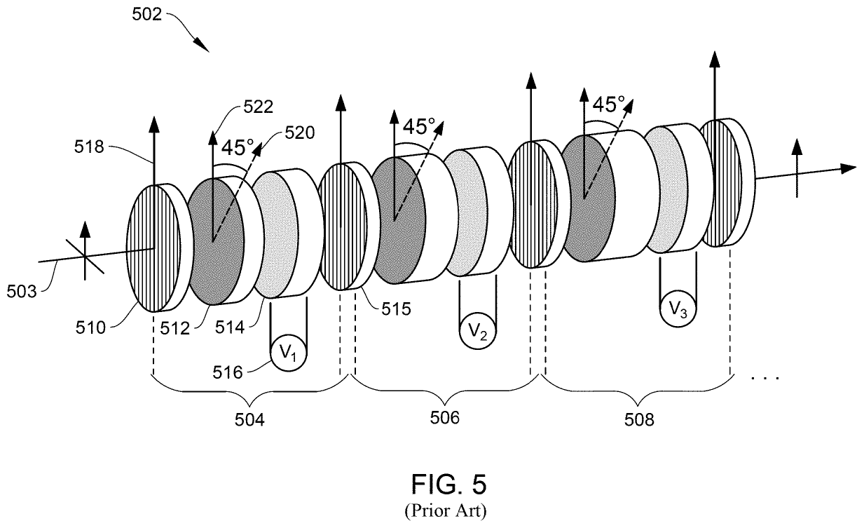

Controller 402 controls the passband of tunable bandpass filter 416 using control line(s) 415, in the manner described with respect to FIG. 3. As shown in the diagram of a liquid crystal tunable filter (LCTF) in FIG. 5, multiple control lines from the controller may be used to control individual stages of the LCTF.

### Liquid Crystal Tunable Filter (LCTF)

A liquid crystal tunable filter (LCTF) uses electronically controlled liquid crystal elements to transmit a selectable wavelength of light and exclude other wavelengths. Many implementations use a Lyot filter, described in FIG. 5 below, but many other designs can be used. The Lyot filter is adapted by replacing fixed wave plates with switchable liquid crystal wave plates.

LCTFs use multiple polarizing elements, which provides high image quality and has lower peak transmission values compared to conventional fixed-wavelength optical filters. LCTFs can be designed to tune to a limited number of fixed wavelengths (e.g., red, green, and blue) or can be tuned in small increments (stages) over a range of wavelengths. For example, they can be tuned to the range of the visible or near-infrared spectrum from 400 to 2450 nm. The tuning speed of LCTFs is typically several tens of milliseconds, mostly determined by the switching speed of the liquid crystal elements. Higher temperatures allow for faster operation, since higher temperatures can decrease the transition time needed for the molecules of the liquid crystal material to align themselves, so that the filter can tune to a particular wavelength. Lower temperatures increase the viscosity of the liquid crystal material and increase the tuning time of the filter from one wavelength to another. Thus, in one optional embodiment, it may be advantageous to include heating resistors near the LCTF to maintain at least a minimum temperature. Current miniaturized electronic driver circuitry have reduced the size requirement of LCTF enclosures while still providing sufficiently large aperture sizes for detecting LiDAR pulses.

FIG. 5 is a diagram illustrating an example embodiment of a liquid crystal tunable filter (LCTF) 502 according to the prior art. LCTF 502 consists of three lyot stages 504, 506 and 508, with light passing through as indicated by arrow 503. Each lyot stage is similar, and more stages could be added. The lyot stages can tune to pass only certain wavelengths, and by including multiple stages, a desired wavelength passband can be achieved. Lyot stage 504 includes a polarizer 510, an anisotropic crystal 512 and a variable liquid crystal retarder 514, followed by a polarizer 515 which is also the first polarizer of lyot stage 506. Polarizer 510 has a polarization axis 518. Anisotropic crystal 512 has an optic axis 520 relative to a vertical axis 522, which is 45° in the example shown. Variable liquid crystal retarder 514 is controlled by a voltage 516 to select the desired wavelengths of this stage of LCTF 502. Other designs of LCTFs using other than lyot stages can be used as well. With control signals controlling the voltages applied to the retarders of each stage, a series of small wavelength bands are selected. The combination of all the small wavelength bands provides the desired passband.

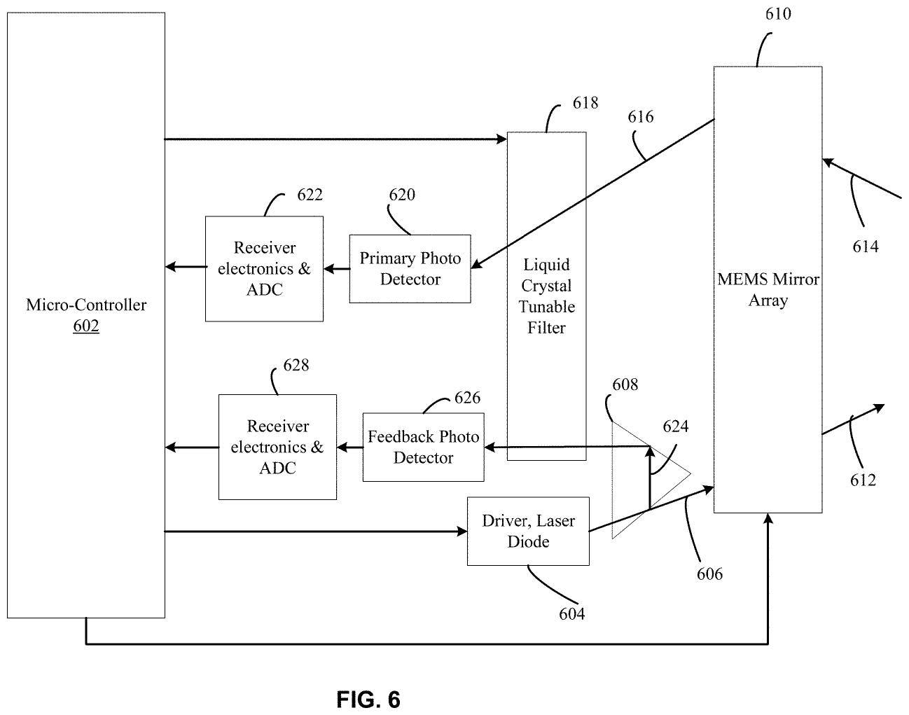

FIG. 6 is a diagram illustrating an embodiment of the control electronics for a tunable filter with feedback control according to certain embodiments. As shown, a microcontroller 602 drives a driver and laser diode 604 which provides a laser beam 606 to a MEMS mirror array 610. MEMS mirror array 610 scans an output laser beam 612 to provide raster scanning of the environment to be detected. The reflected beams 614 are provided the same MEMS array 610, or a different MEMS mirror array, and then are redirected as beam 616 through tunable filter 618 to primary photodetector 620. The analog amplitude signal output of primary photodetector 620 is processed and converted into a digital value by receiver electronics and analog-to-digital converter 622. The digital value is then provided to micro-controller 602.

Separately, a feedback path as described with respect to FIG. 3 is provided. A reflected beam 624 is provided by prism 608, through tunable filter 618, to feedback photodetector 626. The analog amplitude signal output of feedback photodetector 626 is processed and converted into a digital value by receiver electronics and analog-to-digital converter 628. The digital value is then provided to micro-controller 602.

In one embodiment, a 905 nm wavelength laser diode is used. For one type of laser diode, for every 10 degrees Celsius temperature change, there is a 6 nm wavelength change, with the wavelength increasing with temperature. Thus, systems using a bandpass filter would need to pass a 60 nm band, from 875-935, to accommodate a temperature variation of +/−50 degrees. With embodiments of the present invention, a relatively narrow band of +/−5 or +/−10 nm, for example, can be set. In one embodiment, a passband of 25 nm or less is set, such as 20 nm. This narrower band is not limited to +/−50 degrees, and can track the laser wavelength changes due to even greater temperature variations, while maintaining a narrow band around the emitted wavelength.

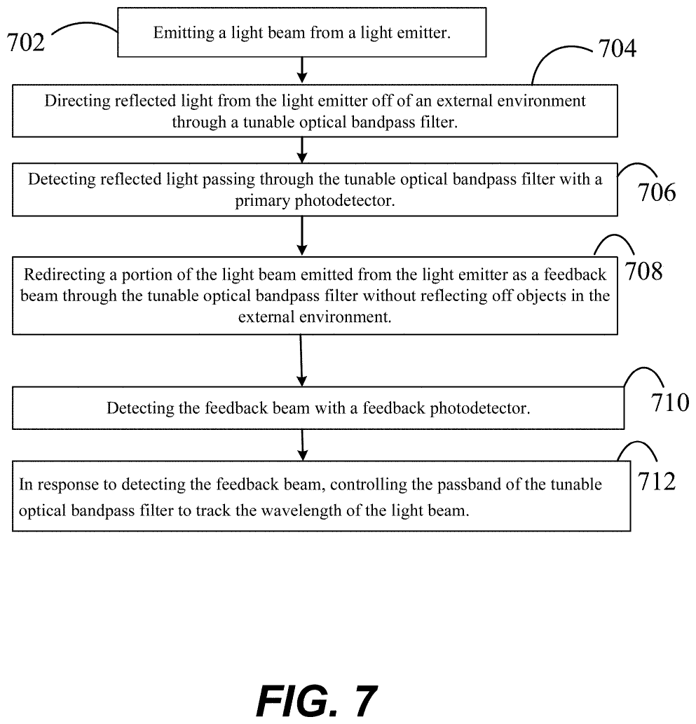

FIG. 7 is a flow chart of a method for feedback control of a tunable filter according to embodiments. Step 702 is emitting a light beam from a light emitter. Step 704 is directing reflected light from the light emitter off an external environment through a tunable optical bandpass filter. Step 706 is detecting reflected light passing through the tunable optical bandpass filter with a primary photodetector. Step 708 is redirecting a portion of the light beam emitted from the light emitter as a feedback beam through the tunable optical bandpass filter without reflecting off objects in the external environment. Step 710 is detecting the feedback beam with a feedback photodetector. Finally, step 712 is, in response to detecting the feedback beam, controlling the passband of the tunable optical bandpass filter to track the wavelength of the light beam.

In summary, embodiments provide an apparatus for detecting a reflected laser beam in a Light Detection and Ranging (LiDAR) system 102 of an autonomous vehicle 100 or other light detection system. The apparatus includes a laser diode 302 emitting a laser beam 304. A tunable optical filter 316 is mounted to receive a reflected laser beam 314 off an object in an external environment, having a passband of less than 20-50 nanometers. A primary photodetector 318 is mounted to receive the reflected laser beam after passing through the tunable optical filter. An optical subsystem 306 redirects less than 5% of the laser beam emitted from the laser diode as a feedback beam through the tunable optical filter without reflecting off objects in the external environment. A feedback photodetector 328 is mounted to detect the feedback beam. A controller 322 is coupled to the feedback photodetector and the tunable optical filter and configured to control the passband of the tunable optical filter to maximize the amplitude of an output signal of the feedback photodetector.

### Example LiDAR System Implementing Aspects of Embodiments Herein

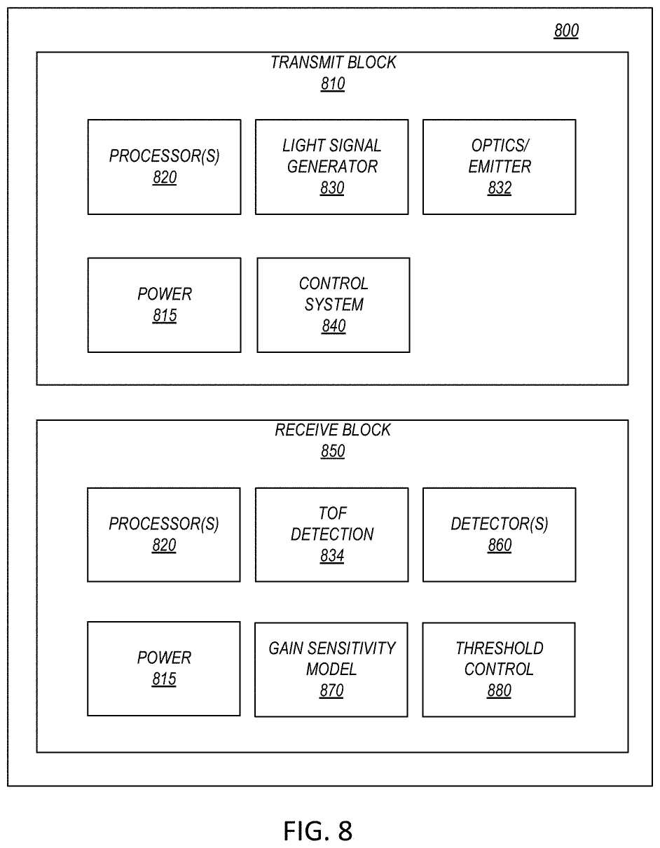

FIG. 8 illustrates a simplified block diagram showing aspects of a LiDAR-based detection system 800 incorporating the tunable bandpass filter feedback system described above, according to certain embodiments. System 800 may be configured to transmit, detect, and process LiDAR signals to perform object detection as described above with regard to LiDAR system 100 described in FIG. 1. In general, a LiDAR system 800 includes one or more transmitters (e.g., transmit block 810) and one or more receivers (e.g., receive block 850). LiDAR system 800 may further include additional systems that are not shown or described to prevent obfuscation of the novel features described herein.

Transmit block 810, as described above, can incorporate a number of systems that facilitate that generation and emission of a light signal, including dispersion patterns (e.g., 360 degree planar detection), pulse shaping and frequency control, Time-Of-Flight (TOF) measurements, and any other control systems to enable the LiDAR system to emit pulses in the manner described above. In the simplified representation of FIG. 8, transmit block 810 can include processor(s) 820, light signal generator 830, optics/emitter module 832, power block 815 and control system 840. Some of all of system blocks 820-840 can be in electrical communication with processor(s) 820.

In certain embodiments, processor(s) 820 may include one or more microprocessors (μCs) and can be configured to control the operation of system 800. Alternatively or additionally, processor 820 may include one or more microcontrollers (MCUs), digital signal processors (DSPs), or the like, with supporting hardware, firmware (e.g., memory, programmable I/Os, etc.), and/or software, as would be appreciated by one of ordinary skill in the art. Alternatively, MCUs, μCs, DSPs, ASIC, programmable logic device, and the like, may be configured in other system blocks of system 800. For example, control system block 840 may include a local processor to certain control parameters (e.g., operation of the emitter). Processor(s) 820 may control some or all aspects of transmit block 810 (e.g., optics/emitter 832, control system 840, dual sided mirror 220 position as shown in FIG. 1, position sensitive device 250, etc.), receive block 850 (e.g., processor(s) 820) or any aspects of LiDAR system 800. Processor(s) 820 also determine, from a detected laser wavelength, the wavelength band to provide to the tunable bandpass filter in one embodiment. In some embodiments, multiple processors may enable increased performance characteristics in system 800 (e.g., speed and bandwidth), however multiple processors are not required, nor necessarily germane to the novelty of the embodiments described herein. Alternatively or additionally, certain aspects of processing can be performed by analog electronic design, as would be understood by one of ordinary skill in the art.

Light signal generator 830 may include circuitry (e.g., a laser diode) configured to generate a light signal, which can be used as the LiDAR send signal, according to certain embodiments. In some cases, light signal generator 830 may generate a laser that is used to generate a continuous or pulsed laser beam at any suitable electromagnetic wavelengths spanning the visible light spectrum and non-visible light spectrum (e.g., ultraviolet and infra-red). In some embodiments, lasers are commonly in the range of 600-1550 nm, although other wavelengths are possible, as would be appreciated by one of ordinary skill in the art.

Optics/Emitter block 832 (also referred to as transmitter 832) may include one or more arrays of mirrors (including but not limited to dual sided mirror 220 as described above in FIGS. 1-6) for redirecting and/or aiming the emitted laser pulse, mechanical structures to control spinning and/or moving of the emitter system, or other system to affect the system field-of-view, as would be appreciated by one of ordinary skill in the art with the benefit of this disclosure. For instance, some systems may incorporate a beam expander (e.g., convex lens system) in the emitter block that can help reduce beam divergence and increase the beam diameter. These improved performance characteristics may mitigate background return scatter that may add noise to the return signal. In some cases, optics/emitter block 832 may include a beam splitter to divert and sample a portion of the pulsed signal. For instance, the sampled signal may be used to initiate the TOF clock. In some cases, the sample can be used as a reference to compare with backscatter signals. Some embodiments may employ micro electromechanical mirrors (MEMS) that can reorient light to a target field. Alternatively or additionally, multi-phased arrays of lasers may be used. Any suitable system may be used to emit the LiDAR send pulses, as would be appreciated by one of ordinary skill in the art.

Power block 815 can be configured to generate power for transmit block 810, receive block 850, as well as manage power distribution, charging, power efficiency, and the like. In some embodiments, power management block 815 can include a battery (not shown), and a power grid within system 800 to provide power to each subsystem (e.g., control system 840, etc.). The functions provided by power management block 815 may be subsumed by other elements within transmit block 810, or may provide power to any system in LiDAR system 800. Alternatively, some embodiments may not include a dedicated power block and power may be supplied by a number of individual sources that may be independent of one another.

Control system 840 may control aspects of light signal generation (e.g., pulse shaping), optics/emitter control, TOF timing, or any other function described herein. In some cases, aspects of control system 840 may be subsumed by processor(s) 820, light signal generator 830, or any block within transmit block 810, or LiDAR system 800 in general.

Receive block 850 may include circuitry configured to detect and process a return light pulse to determine a distance of an object, and in some cases determine the dimensions of the object, the velocity and/or acceleration of the object, and the like. This block includes the tunable bandpass filter feedback system described above. Processor(s) 1065 may be configured to perform operations such as processing received return pulses from detectors(s) 860, controlling the operation of TOF module 834, controlling threshold control module 880, or any other aspect of the functions of receive block 850 or LiDAR system 800 in general. Processor(s) 1065 also control the mirror array in the tunable bandpass filter feedback system as described above.

TOF module 834 may include a counter for measuring the time-of-flight of a round trip for a send and return signal. In some cases, TOF module 834 may be subsumed by other modules in LiDAR system 800, such as control system 840, optics/emitter 832, or other entity. TOF modules 834 may implement return “windows” that limit a time that LiDAR system 800 looks for a particular pulse to be returned. For example, a return window may be limited to a maximum amount of time it would take a pulse to return from a maximum range location (e.g., 250 m). Some embodiments may incorporate a buffer time (e.g., maximum time plus 10%). TOF module 834 may operate independently or may be controlled by other system block, such as processor(s) 820, as described above. In some embodiments, transmit block may also include a TOF detection module. One of ordinary skill in the art with the benefit of this disclosure would appreciate the many modification, variations, and alternative ways of implementing the TOF detection block in system 800.

Detector(s) 860 may detect incoming return signals that have reflected off one or more objects, and can include primary photodetector 318 and receiver electronics 320 (which can also include gain sensitivity module 870 and threshold control 880, described below). In some cases, LiDAR system 800 may employ spectral filtering based on wavelength, polarization, and/or range to help reduce interference, filter unwanted frequencies, or other deleterious signals that may be detected. Typically, detector(s) 860 can detect an intensity of light and records data about the return signal (e.g., via coherent detection, photon counting, analog signal detection, or the like). Detector (s) 860 can use any suitable photodetector technology including solid state photodetectors (e.g., silicon avalanche photodiodes, complimentary metal-oxide semiconductors (CMOS), charge-coupled devices (CCD), hybrid CMOS/CCD devices) or photomultipliers. In some cases, a single receiver may be used or multiple receivers may be configured to operate in parallel.

Gain sensitivity model 870 may include systems and/or algorithms for determining a gain sensitivity profile that can be adapted to a particular object detection threshold. The gain sensitivity profile can be modified based on a distance (range value) of a detected object (e.g., based on TOF measurements). In some cases, the gain profile may cause an object detection threshold to change at a rate that is inversely proportional with respect to a magnitude of the object range value. A gain sensitivity profile may be generated by hardware/software/firmware, or gain sensor model 870 may employ one or more look up tables (e.g., stored in a local or remote database) that can associate a gain value with a particular detected distance or associate an appropriate mathematical relationship there between (e.g., apply a particular gain at a detected object distance that is 10% of a maximum range of the LiDAR system, apply a different gain at 15% of the maximum range, etc.). In some cases, a Lambertian model may be used to apply a gain sensitivity profile to an object detection threshold. The Lambertian model typically represents perfectly diffuse (matte) surfaces by a constant bidirectional reflectance distribution function (BRDF), which provides reliable results in LiDAR system as described herein. However, any suitable gain sensitivity profile can be used including, but not limited to, Oren-Nayar model, Nanrahan-Krueger, Cook-Torrence, Diffuse BRDF, Limmel-Seeliger, Blinn-Phong, Ward model, HTSG model, Fitted Lafortune Model, or the like. One of ordinary skill in the art with the benefit of this disclosure would understand the many alternatives, modifications, and applications thereof.

Threshold control block 880 may set an object detection threshold for LiDAR system 800. For example, threshold control block 880 may set an object detection threshold over a certain a full range of detection for LiDAR system 800. The object detection threshold may be determined based on a number of factors including, but not limited to, noise data (e.g., detected by one or more microphones) corresponding to an ambient noise level, and false positive data (typically a constant value) corresponding to a rate of false positive object detection occurrences for the LiDAR system. In some embodiments, the object detection threshold may be applied to the maximum range (furthest detectable distance) with the object detection threshold for distances ranging from the minimum detection range up to the maximum range being modified by a gain sensitivity model (e.g., Lambertian model).

Although certain systems may not expressly discussed, they should be considered as part of system 800, as would be understood by one of ordinary skill in the art. For example, system 800 may include a bus system (e.g., CAMBUS) to transfer power and/or data to and from the different systems therein. In some embodiments, system 800 may include a storage subsystem (not shown). A storage subsystem can store one or more software programs to be executed by processors (e.g., in processor(s) 820). It should be understood that “software” can refer to sequences of instructions that, when executed by processing unit(s) (e.g., processors, processing devices, etc.), cause system 800 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations (e.g., software-controlled spring auto-adjustment, etc.) as described herein. Some software controlled aspects of LiDAR system 800 may include aspects of gain sensitivity model 870, threshold control 880, control system 840, TOF module 834, or any other aspect of LiDAR system 800.

It should be appreciated that system 800 is meant to be illustrative and that many variations and modifications are possible, as would be appreciated by one of ordinary skill in the art. System 800 can include other functions or capabilities that are not specifically described here. For example, LiDAR system 800 may include a communications block (not shown) configured to enable communication between LiDAR system 800 and other systems of the vehicle or remote resource (e.g., remote servers), etc., according to certain embodiments. In such cases, the communications block can be configured to provide wireless connectivity in any suitable communication protocol (e.g., radio-frequency (RF), Bluetooth, BLE, infra-red (IR), ZigBee, Z-Wave, Wi-Fi, or a combination thereof).

While system 800 is described with reference to particular blocks (e.g., threshold control block 880), it is to be understood that these blocks are defined for understanding certain embodiments of the invention and is not intended to imply that embodiments are limited to a particular physical arrangement of component parts. The individual blocks need not correspond to physically distinct components. Blocks can be configured to perform various operations, e.g., by programming a processor or providing appropriate processes, and various blocks may or may not be reconfigurable depending on how the initial configuration is obtained. Certain embodiments can be realized in a variety of apparatuses including electronic devices implemented using any combination of circuitry and software. Furthermore, aspects and/or portions of system 800 may be combined with or operated by other sub-systems as informed by design. For example, power management block 815 and/or threshold control block 880 may be integrated with processor(s) 820 instead of functioning as separate entities.

### Example Computer Systems Implementing Aspects of Embodiments Herein

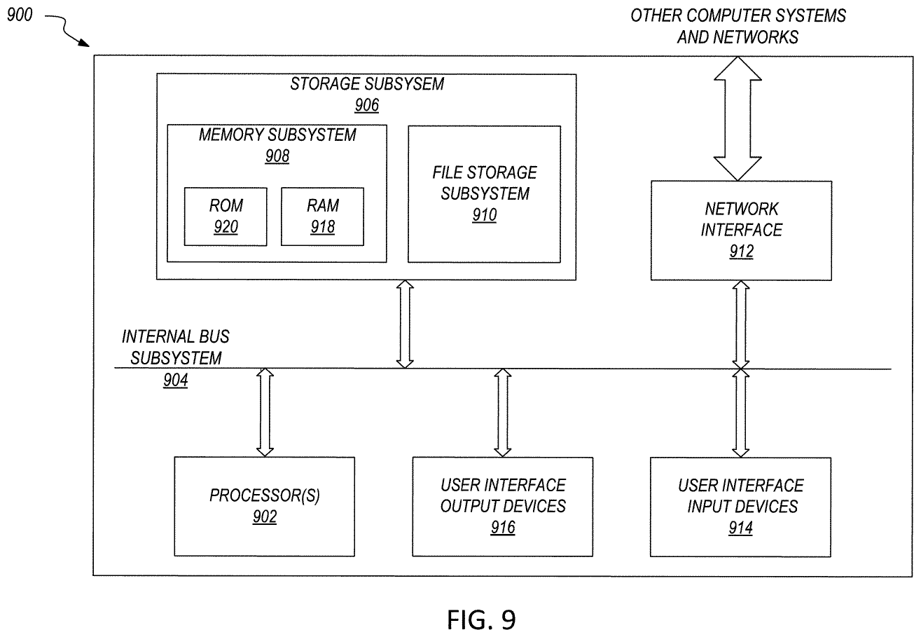

FIG. 9 is a simplified block diagram of computer system 900 configured to operate aspects of a LiDAR-based detection system, according to certain embodiments. Computing system 900 can be used to implement any of the systems and modules discussed above with respect to FIGS. 1-6. For example, computing system 900 may operate aspects of threshold control 880, TOF module 834, processor(s) 820, control system 840, or any other element of LiDAR system 800 or other system described herein. Computing system 900 can include, for example, a field programmable gate array (FPGA), an application specific integrated circuit (ASIC), and a general purpose central processing unit (CPU), to implement the disclosed techniques, including the techniques described from FIG. 1-FIG. 9, such as microcontroller 322. In some examples, computing system 1100 can also can also include one or more processors 902 that can communicate with a number of peripheral devices (e.g., input devices) via a bus subsystem 904. These peripheral devices can include storage subsystem 906 (comprising memory subsystem 908 and file storage subsystem 910), user interface input devices 914, user interface output devices 916, and a network interface subsystem 912.

In some examples, internal bus subsystem 904 (e.g., CAMBUS) can provide a mechanism for letting the various components and subsystems of computer system 900 communicate with each other as intended. Although internal bus subsystem 904 is shown schematically as a single bus, alternative embodiments of the bus subsystem can utilize multiple buses. Additionally, network interface subsystem 912 can serve as an interface for communicating data between computing system 900 and other computer systems or networks. Embodiments of network interface subsystem 912 can include wired interfaces (e.g., Ethernet, CAN, RS232, RS485, etc.) or wireless interfaces (e.g., ZigBee, Wi-Fi, cellular, etc.).

In some cases, user interface input devices 914 can include a keyboard, pointing devices (e.g., mouse, trackball, touchpad, etc.), a barcode scanner, a touch-screen incorporated into a display, audio input devices (e.g., voice recognition systems, microphones, etc.), Human Machine Interfaces (HMI) and other types of input devices. In general, use of the term “input device” is intended to include all possible types of devices and mechanisms for inputting information into computing system 900. Additionally, user interface output devices 916 can include a display subsystem, a printer, or non-visual displays such as audio output devices, etc. The display subsystem can be any known type of display device. In general, use of the term “output device” is intended to include all possible types of devices and mechanisms for outputting information from computing system 900.

Storage subsystem 906 can include memory subsystem 908 and file/disk storage subsystem 910. Subsystems 908 and 910 represent non-transitory computer-readable storage media that can store program code and/or data that provide the functionality of embodiments of the present disclosure. In some embodiments, memory subsystem 908 can include a number of memories including main random access memory (RAM) 918 for storage of instructions and data during program execution and read-only memory (ROM) 920 in which fixed instructions may be stored. File storage subsystem 910 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art. The memory system can contain a look-up table providing the wavelength corresponding to a detected temperature of the laser diode.

It should be appreciated that computer system 900 is illustrative and not intended to limit embodiments of the present disclosure. Many other configurations having more or fewer components than computing system 900 are possible.

The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local-area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, any of the examples, alternative examples, etc., and the concepts thereof may be applied to any other examples described and/or within the spirit and scope of the disclosure.

For example, instead of using a single laser to illuminate the array of MEMS mirrors, an array of mirrors may be used. Also, the pattern generation and decoding could be hard-wired, in firmware or in software in different embodiments.

The tunable bandpass filter feedback structure of the present invention can be used in a variety of other applications than LIDAR. Light beam steering techniques can also be used in other optical systems, such as optical display systems (e.g., TVs), optical sensing systems, optical imaging systems, and the like. In various light beam steering systems, the light beam may be steered by, for example, a rotating platform driven by a motor, a multi-dimensional mechanical stage, a Galvo-controlled mirror, a resonant fiber, an array of microelectromechanical (MEMS) mirrors, or any combination thereof. A MEMS micro-mirror may be rotated around a pivot or connection point by, for example, a micro-motor, an electromagnetic actuator, an electrostatic actuator, or a piezoelectric actuator.

The MEMS mirror structure of the present invention can have the mirror mass driven by different types of actuators. In some light steering systems, the transmitted or received light beam may be steered by an array of micro-mirrors. Each micro-mirror may rotate around a pivot or connection point to deflect light incident on the micro-mirror to desired directions. The performance of the micro-mirrors may directly affect the performance of the light steering system, such as the field of view (FOV), the quality of the point cloud, and the quality of the image generated using a light steering system. For example, to increase the detection range and the FOV of a LiDAR system, micro-mirrors with large rotation angles and large apertures may be used, which may cause an increase in the maximum displacement and the moment of inertia of the micro-mirrors. To achieve a high resolution, a device with a high resonant frequency may be used, which may be achieved using a rotating structure with a high stiffness. It may be difficult to achieve this desired performance using electrostatic actuated micro-mirrors because comb fingers used in an electrostatic-actuated micro-mirror may not be able to provide the force and moment needed and may disengage at large rotation angles, in particular, when the aperture of the micro-mirror is increased to improve the detection range. Some piezoelectric actuators may be used to achieve large displacements and large scanning angles due to their ability to provide a substantially larger drive force than electrostatic-actuated types, with a relatively lower voltage.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

What is claimed is:

1. An apparatus for detecting a reflected laser beam in a Light Detection and Ranging (LiDAR) system of an autonomous vehicle, the apparatus comprising:
a laser diode emitting a laser beam;
a tunable optical filter mounted to receive a reflected laser beam off an object in an external environment, having a passband of less than 50 nanometers;
a primary photodetector mounted to receive the reflected laser beam after passing through the tunable optical filter;
an optical subsystem for redirecting less than 25% of the laser beam emitted from the laser diode as a feedback beam through the tunable optical filter without reflecting off objects in the external environment;
a feedback photodetector mounted to detect the feedback beam; and
a controller coupled to the feedback photodetector and the tunable optical filter and configured to control the passband of the tunable optical filter to maximize an amplitude of an output signal of the feedback photodetector.

2. The apparatus of claim 1 wherein the tunable optical filter comprises a Liquid Crystal Tunable Filter (LCTF).

3. The apparatus of claim 1 wherein the tunable optical filter comprises a Micro-Electro-Mechanical System (MEMS) Fabry-Perot filter.

4. The apparatus of claim 1 wherein the optical subsystem comprises a prism.

5. The apparatus of claim 1 wherein the tunable optical filter comprises a Liquid Crystal Tunable Filter (LCTF) and further comprising:
a heater mounted proximate to the LCTF;
a thermistor mounted proximate to the LCTF;
the controller being coupled to the heater to cause the heater to maintain a temperature output of the thermistor to above a designated temperature level that will maintain a switching speed of the LCTF below a selected target speed;
wherein the controller provides a varying voltage level to the heater to maintain the temperature output of the thermistor to above the designated temperature level; and
wherein the heater comprises at least one resistor.

6. The apparatus of claim 1 further comprising:
a first analog-to-digital converted coupled between the primary photodetector and the controller; and
a second analog-to-digital converted coupled between the feedback photodetector and the controller.

7. An apparatus comprising:
a laser emitting a laser beam;
a tunable optical filter mounted to receive a reflected laser beam off an object in an external environment;
a primary photodetector mounted to receive the reflected laser beam after passing through the tunable optical filter;
an optical subsystem for redirecting a portion of the laser beam emitted from the laser as a feedback beam through the tunable optical filter without reflecting off objects in the external environment;
a feedback photodetector mounted to detect the feedback beam; and
a controller coupled to the feedback photodetector and the tunable optical filter and configured to control a passband of the tunable optical filter to track a wavelength of the laser beam.

8. The apparatus of claim 7 wherein the tunable optical filter has a passband of 25 nanometers or less.

9. The apparatus of claim 7 wherein the portion of the laser beam emitted from the laser as a feedback beam is less than 10% of the laser beam emitted from the laser.

10. The apparatus of claim 7 wherein the tunable optical filter comprises a Liquid Crystal Tunable Filter (LCTF).

11. The apparatus of claim 7 wherein the tunable optical filter comprises a Micro-Electro-Mechanical System MEMS Fabry-Perot filter.

12. The apparatus of claim 7 wherein the optical subsystem comprises a prism.

13. The apparatus of claim 7 wherein the laser is a laser diode.

14. The apparatus of claim 7 wherein the tunable optical filter comprises a Liquid Crystal Tunable Filter (LCTF) and further comprising:
a heating resistor mounted proximate to the LCTF;
a thermistor mounted proximate to the LCTF;
the controller being coupled to the heating resistor to cause the heating resistor to maintain a temperature output of the thermistor to above a designated temperature level that will maintain a switching speed of the LCTF below a selected target speed; and
wherein the controller provides a varying voltage level to the heating resistor to maintain the temperature output of the thermistor to above the designated temperature level.

15. The apparatus of claim 7 further comprising:
a Micro-Electro-Mechanical System (MEMS) mirror mounted to scan the laser beam across the external environment.

16. The apparatus of claim 7 wherein the optical subsystem comprises a coated glass plate.

17. A method comprising:
emitting a light beam from a light emitter;
directing reflected light from the light emitter off an external environment through a tunable optical bandpass filter;
detecting the reflected light passing through the tunable optical bandpass filter with a primary photodetector;
redirecting a portion of the light beam emitted from the light emitter as a feedback beam through the tunable optical bandpass filter without reflecting off objects in the external environment;
detecting the feedback beam with a feedback photodetector; and
in response to detecting the feedback beam, controlling a passband of the tunable optical bandpass filter to track a wavelength of the light beam.

18. The method of claim 17 wherein the feedback beam comprises less than 5% of the light beam.

19. The method of claim 17 further comprising:
controlling the passband of the tunable optical filter to be 25 nanometers or less.

20. The method of claim 17 wherein controlling the passband of the tunable optical bandpass filter to track the wavelength of the light beam comprises setting the passband of the tunable optical bandpass filter to maximize an amplitude of an output signal of the feedback photodetector.
